(19) United States
(12) Patent Application Publication
(10) Pub. No.: US 2007/0241235 A1
(43) Pub. Date: Oct. 18, 2007

(54) SEATING ARRANGEMENT FOR A PASSENGER AIRPLANE

(76) Inventor: Jim D. Atchison, Sullivan, MO (US)

Correspondence Address: LAW OFFICE OF STEVEN B. LEAVITT, L.L.P., P.O. BOX 537, ROWLETT, TX, 75030-0537, US

(21) Appl. No.: 11/279,897

(22) Filed: Apr. 16, 2006

(51) Int. Cl. B64D 11/06

(52) U.S. Cl. 244/122 R

(57) ABSTRACT

Modified airplane seating comprises a typical row of standard economy-class airplane seats that include a raised middle seat with dedicated armrests with aisle or window seats on each side of the middle seat forming a staggered configuration. The raised middle seat comprises of a seat back portion, seat portion, and armrests. The height of the seat of the middle seat is higher than the standard economy-class seat. The armrest provides dedicated armrest for both the raised middle seat and the end or window seats. The middle seat and end or window seats, usually configured in a straight row in the economy-class section of an airplane, is in a staggered configuration with the middle seat is moved slightly forward of the seats beside it.

### BACKGROUND OF THE INVENTION

1. Technical Field

This invention relates generally to seating in airplanes, and more particularly, to airplane seating in the coach class, or “economy” class, section of an airplane wherein the seats are more comfortable, inviting, and accommodating to travelers.

2. Description of Related Art

Seating on airplanes, outside of that in the first and business class sections, appears to be designed to accommodate as many passengers as possible in the space allocated for the specific section. Comfort of these passengers does not appear to be an airline priority. In the three-seat abreast row seating configuration common in the economy class, the discomfort experienced by those sitting in the middle seat is practically legend.

The middle seat typically shares an armrest with the seats on its left and right and often, the passenger in the middle seat cannot use their armrest without touching a neighbor, that is, if the neighbor has not already decided to use the armrest themselves. Also, the middle seat, already widely considered cramped for the average passenger, is almost unbearable for the passenger that is above average in height. The cramped conditions and uncomfortably close proximity to a passenger on either side makes the middle seat the most undesirable seat on the airplane.

To increase the comfort of an aircraft's economy class seating, changes to conventional seating configurations, and the seats themselves, have been disclosed in the prior art. However, prior attempts to resolve the problem suffer from at least one of the following disadvantages: (a) each seat does not have dedicated armrests; (b) if airline seats are arranged with an eye toward airline profit and passenger comfort, those modifications do not include arrangements outside of a typical row or any physical changes to the airline seats themselves; and/or (c) physical changes made to seats do not make a middle seat more accommodating to a taller passenger.

While the prior art discloses more comfortable airline economy class seating through modifications to seat design and configuration, seating that increases the comfort and desirability of the “dreaded” middle seat with a raised middle seat, ergonomic armrests, and a staggered configuration is not disclosed. What is needed is airline seating in an airplane's economy class section that has all these features.

### SUMMARY

The present invention is directed to more comfortable airline seating through modifications to seat design and configuration with a raised middle seat, ergonomic armrests that are dedicated armrests for the middle, aisle, and window seat, and a staggered configuration.

The raised middle seat comprises of a seat back portion, seat portion, and armrests. The height of the seat portion of the middle seat is preferably four inches higher than the standard economy-class seat while the width of the middle seat remains similar to that of a standard economy-class airplane seat. The armrest comprises of a vertical, planar center portion terminating in a slightly angled upper armrest portion and a flat, horizontal lower armrest portion. The armrest provides a dedicated armrest for both the raised middle seat and the aisle or window seats. The upper armrest portion serves as an armrest solely for the raised middle seat while the lower armrest portion, located below the upper armrest portion, serves as an armrest solely for the aisle or window seat.

The middle seat and aisle or window seat, usually configured in a straight row in the economy-class section of an airplane, is in a staggered configuration. Preferably, the middle seat is moved about four inches forward of the aisle or window seats beside it while those seats remain in their original positions. This staggered configuration increases the seat pitch, or the horizontal legroom, available to the passenger in the middle seat.

Both the staggered configuration and raised middle seat of airplane seating in accordance with the present invention make the once dreaded middle seat a desirable option for airline travelers, especially for those of above-average height.

### BRIEF DESCRIPTION OF THE DRAWINGS

These and other features, aspects, and advantages of the present invention will become better understood with regard to the following description, appended claims, and accompanying drawings where:

FIG. 1 is a front view of a conventional seating configuration in an economy class section of a commercial airplane;

FIG. 2 is a front view of another conventional seating configuration in an economy class section of an airplane;

FIG. 3 is top view of the typical airplane seating configuration shown in FIG. 1;

FIG. 4 is a front, perspective view of a preferred embodiment of the airline seating in accordance with the present invention;

FIG. 5 is a front, perspective view of one modified middle seat in accordance with the present invention;

FIG. 6 is a top view of one row of seating in accordance with the present invention; and

FIG. 7 is a top view of two rows of seating in accordance with the present invention.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

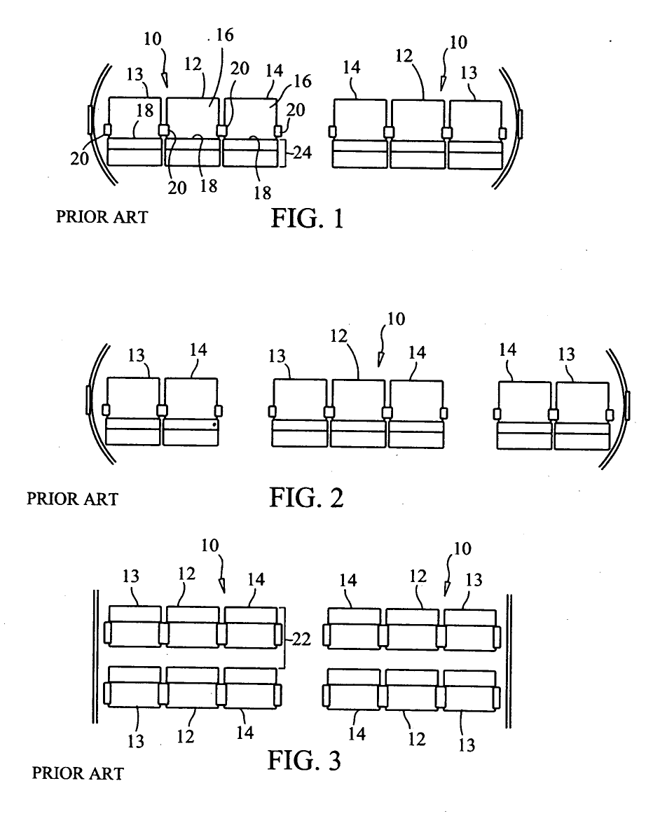

Typical examples of conventional seating formats in the economy class section of a commercial airplane are illustrated in FIGS. 1, 2 and 3. The seats are typically positioned in a straight row with a number of seats side-by-side, as shown in FIGS. 1, 2, and 3, including a section of the row with three seats side-by-side, shown as row 10. Row 10 depicts a typical three seat configuration and contains aisle seat 14, window seat 13, and middle seat 12 wherein middle seat 12 is between aisle seat 14 and window seat 13.

FIG. 2 shows an alternate three seat configuration where middle seat 12 is between two aisle seats 14. As illustrated in FIG. 1, aisle seat 14, window seat 13, and middle seat 12 are standard airline seats and comprise seat back portion 16, seat portion 18 and armrests 20. Aisle seat 14, window seat 13, and middle seat 12 typically have a width of about 17 to 18 inches. Seat pitch 22, shown in FIG. 3, is the distance from any point on one seat to the exact same point on the seat in front or behind it, and is about 31 to 32 inches. Seat portion 18 of aisle seat 14, window seat 13, and middle seat 12, is a factor in determining leg room in an airplane and the lower seat portion 18 is relative to the passenger compartment floor of the aircraft, the more cramped a typical passenger will feel. In a typical airplane, the height of seat portion 18, shown as height 24, FIG. 1, is about 26 inches.

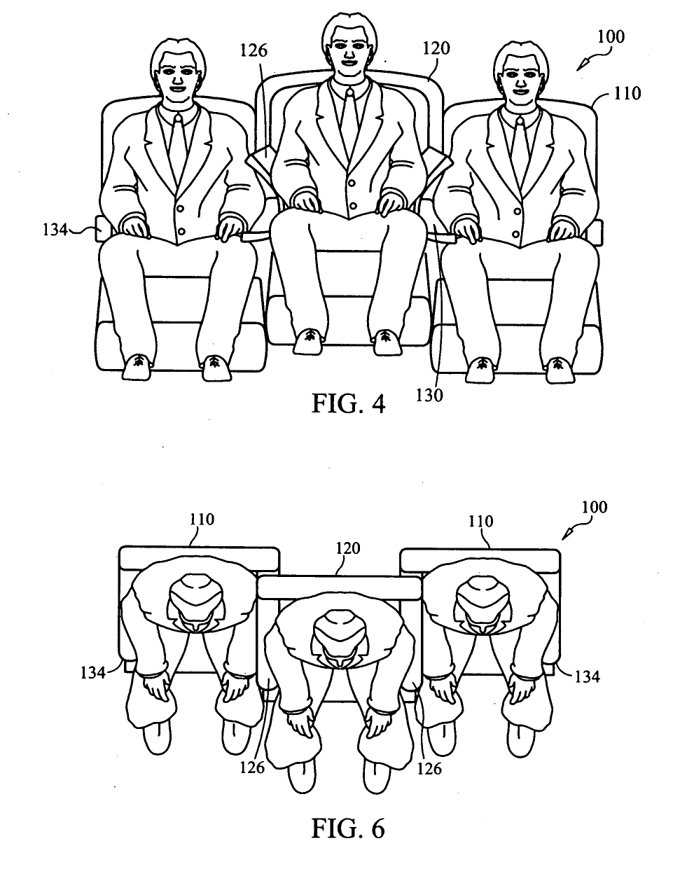

FIG. 4 shows airplane seating configuration 100, a preferred embodiment of the modifications to a typical row of airplane seats in accordance with present invention. Airplane seating configuration 100 includes dedicated armrests 126 for raised middle seat 120 and end seat dedicated armrests 130 for end seat 110. End seat 110 is a typical economy class seat on either side of raised middle seat 120 and would be proximate to a window or an aisle on the airplane. End armrest 130 of end seat 110 is the one that is proximate to middle seat 120. End armrest 134 of end seat 110 is the one that is proximate either to a window or to an aisle.

As shown in FIG. 4, raised middle seat 120 comprises seat back portion 122, seat portion 124, dedicated armrests 126, and end seat dedicated armrests 130. Seat back portion 122 is of the same width as standard economy-class middle seat 12 shown in FIG. 1. Seat portion 124 also has the same width as standard economy-class middle seat 12 but has a height 128 of about 0.5 to about 8 inches higher, preferably about 4 inches higher, than height 24 of standard economy-class middle seat 12. By making height 128 about 0.5 to about 8 inches higher, the typical passenger will not feel as cramped and the comfort and desirability of the “dreaded” middle seat will be increased.

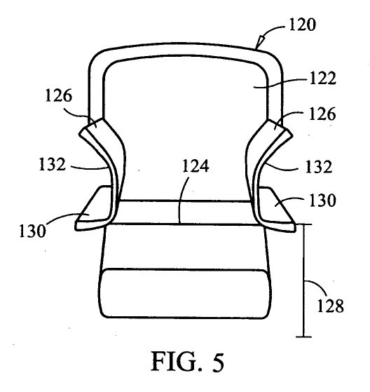

Dedicated armrest 126 provides the passenger in raised middle seat 120 with its own dedicated armrest, as shown in FIG. 5. Dedicated armrest 126 is slightly angled upward and outward to provide maximum comfort for the passenger in raised middle seat 120. However, as would be apparent to one skilled in the art, dedicated armrest may have almost any profile that would be relatively comfortable to the passenger in raised middle seat 120. Dedicated armrest 126 extends down to vertical, planar center portion 132.

Planar center portion 132 prevents passengers in end seat 110 from invading the space of the passenger in raised middle seat 120. Planer center portion 132 extends down to and terminates at end seat dedicated armrest 130. End seat dedicated armrest 130 provides a dedicated armrest for passengers to use in an end seat 110. Dedicated armrest 126 is angled about 45 degrees up and away from the side of middle seat 120 to provide the passenger in end seat 110 with enough space to comfortably use end seat dedicated armrest 130.

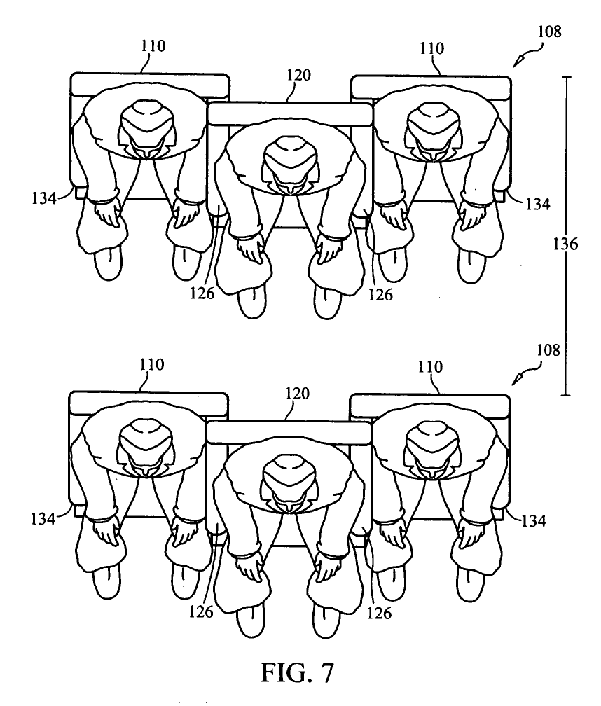

In addition to raised middle seat 120 and dedicated armrest 126, airplane seating configuration 100 has a staggered configuration as shown in FIGS. 5 and 6 wherein middle seat 120 is positioned about 1 to about 8 inches forward of end seat 110, and preferably about four inches forward of end seat 110. In airplane seating configuration 100, end seat 110 remains in its original position as shown in FIG. 3. As the staggered configuration is repeated in the economy class section of the airplane cabin, the perception of more horizontal legroom is created for the passenger in the raised middle seat 120. The perception is created because a passenger in the raised middle seat 120 sees that the seat in front of them is positioned about 1 to about 8 inches forward of end seat 110 creating the illusion of an extended seat pitch 136 as shown in FIG. 7.

In use, airplane seating configuration 100 provides all the passengers in middle seat 120 and all the passengers in end seat 110 with their own dedicated armrests. The increased height 128 of raised middle seat 120 not only assists in providing each passenger with their own armrests, as shown in FIG. 5, but also increases the vertical legroom of this seat making it very desirable to a tall passenger.

In addition, as discussed previously, the staggered configuration creates the perception of an increased seat pitch 136, or horizontal legroom available to the passenger sitting in middle seat 120 and is another characteristic of airplane seating configuration 100 that makes middle seat 120 very desirable to taller passengers. The modifications to conventional economy-class seating embodied in airplane seating configuration 100 create a middle seat that is comfortable, accommodating and desirable to a majority of airplane passengers.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims. For example, while the seating configuration has been described for use on an airplane, it would be obvious to modify the seating configuration for use on a train, bus, or other passenger vehicle where there are multiple seats in rows. Also, while the seating configuration has been described for use in the economy class section, it could also be used in the business class or even the first class section to enhance the passenger experience is those sections.

What is claimed is:

1. An improved airplane seating configuration, the configuration comprising:
a row of three seats wherein the row comprises a middle seat and two outside seats wherein the middle seat is between the two outside seats and the middle seat is raised between about 0.5 inches to about 8 inches higher than the outside seats.

2. The airplane seating configuration of claim 1 also comprising dedicated armrests for the middle seat and dedicated armrests for the two outside seats.

3. The airplane seating configuration of claim 1 wherein the middle seat is raised about 4 inches higher than the outside seats.

4. The airplane seating configuration of claim 1 further comprising a staggered seating configuration of the row of three seats wherein the raised middle seat is extended about 1 inch to about 8 inches forward relative to the outside seats.

5. The airplane seating configuration of claim 4 wherein the raised middle seat is extended about 4 inches forward relative to the outside seats.

6. The airplane seating in claim 1 wherein said raised middle seat comprises:
a seatback portion;
a seat portion; and
armrests.

7. The airplane seating in claim 6 wherein the seatback portion is of a height and width similar to the seatbacks of standard airplane seats.

8. The airplane seating in claim 7 wherein said seating portion is of a width similar to the seating portion of standard seats.

9. The airplane seating in claim 2 wherein the armrest are comprised of a vertical, planar center portion terminating in an angled upper armrest portion and a flat, horizontal lower armrest portion.

10. The airplane seating in claim 8 wherein said angled upper armrest portion is angled up and away from the side of said middle seat.

11. The airplane seating in claim 8 wherein said angled upper armrest portion is above said flat horizontal lower portion.

12. The airplane seating in claim 8 wherein said angled upper armrest portion provides a dedicated armrest for said raised middle seat.

13. The airplane seating in claim 8 where said flat, horizontal lower armrest portion provides a dedicated armrest for the outside seat.

14. A method for improving the seating on an airplane, the method comprising the steps of:
locating a standard row of three seats wherein the row comprises a middle seat and two outside seats wherein the middle seat is between the two outside seats; and
reconfiguring the row wherein the middle seat is raised between about 0.5 inches to about 8 inches higher than the outside seats.

15. The method of claim 14 wherein the middle seat is raised about 4 inches higher than the outside seats.

16. The method of claim 14 further comprising the step of adding dedicated armrests for the middle seat and dedicated armrests for the two outside seats.

17. The method of claim 16 wherein the armrest are comprised of a vertical, planar center portion terminating in an angled upper armrest portion and a flat, horizontal lower armrest portion.

18. The method of claim 17 wherein said angled upper armrest portion is angled up and away from the side of said middle seat.

19. The method of claim 14 further comprising the step of staggering the seating configuration of the row of three seats wherein the raised middle seat is extended about 1 inch to about 8 inches forward relative to the outside seats.

20. The method of claim 19 wherein the raised middle seat is extended about 4 inches forward relative to the outside seats.
